(19) United States
(12) Patent Application Publication
(10) Pub. No.: US 2010/0022469 A1
(43) Pub. Date: Jan. 28, 2010

(54) ANTHELMINTHIC FORMULATIONS

(76) Inventor: Majid Razzak, (US)

Correspondence Address: Judy Jarecki-Black, Ph.D, J.D.;Merial LTD., 3239 Satellite Blvd., Duluth, GA, 30096, US

(21) Appl. No.: 12/490,965

(22) Filed: Jun. 24, 2009

Related U.S. Application Data
(60) Provisional application No. 61/075,071, filed on Jun. 24, 2008.

(51) Int. Cl. A01N 43/16

(52) U.S. Cl. 514/53; 514/453

(57) ABSTRACT

The present invention relates to veterinary or pharmaceutical antiparasitic formulations which may comprise a macrocyclic lactone, one or more alcohol cosolvents and an oil wherein the crystallization of the macrocyclic lactone is minimalized. This invention also provides for, inter alia, antiparasitic formulations for the treating, controlling and preventing of endo- and ectoparasite infections in warm-blooded animals, such as livestock.

### CROSS REFERENCE TO RELATED APPLICATIONS

This application claims the benefit of U.S. Provisional Application No. 61/075,071, filed Jun. 24, 2008, which is incorporated herein by reference in its entirety.

### INCORPORATION BY REFERENCE

All documents cited or referenced herein (“herein cited documents”), together with any manufacturer's instructions, descriptions, product specifications, and product sheets for any products mentioned herein or in any document incorporated by reference herein, are hereby incorporated herein by reference, and may be employed in the practice of the invention.

### FIELD OF THE INVENTION

This invention relates to improvements in the field of veterinary remedies and more particularly to improvements in relation to anti-parasitic formulations containing macrocyclic lactones.

### BACKGROUND OF THE INVENTION

Anti-parasitic agents from the class of macrocyclic lactones are difficult to formulate due to their solubility characteristics. Oils may be used as solvents in formulations containing these actives. However, stability of the formulations can be a problem. The formulations should be capable of storage over a prolonged period without significant chemical or physical deterioration occurring. Such deterioration can take the form of physical separation of the components, colour changes, reduction in potency of the active ingredient(s), and/or crystallization of the carrier and/or active ingredient(s).

Examples of anti-parasitic formulations containing macrocyclic lactones are illustrated in U.S. Pat. No. 6,013,636. These formulations relate to an anthelmintic compound selected from the class of macrocyclic lactones dissolved in a mixture of a vegetable oil and an alcohol having four or more carbon atoms. A preferred blend of solvents for such formulations may include soya bean oil and benzyl alcohol. The '636 patent also pertains to oral, topical (pour-on) and injectable formulations.

Such formulations have been successful in many markets, however for certain macrocyclic lactones, or when the concentration of the macrocyclic lactone is increased, there has been the possibility of crystallization of the active ingredient occurring. In particular, in formulations containing an avermectin, benzyl alcohol and a vegetable oil it has been found that when the ingredients are present in certain ratios there is a tendency for the avermectin to crystallize and precipitate out of the formulation over time. Therefore, there is a need for improved formulations comprising macrocyclic lactone active agents with improved solution stability with a reduced tendency of the active agent to crystallize or precipitate from the formulation.

Citation or identification of any document in this application is not an admission that such document is available as prior art to the present invention.

### SUMMARY OF THE INVENTION

In a first aspect the invention relates an anti-parasitic formulation which may comprise: (a) one or more macrocyclic lactone anthelmintic compounds, (b) an alcohol co-solvent having four or more carbon atoms present in an amount of at least 17% by weight, (c) castor oil present in an amount of 25% by weight or less, and (d) a vegetable oil wherein the vegetable oil is an oil other than castor oil.

Advantageously, the anthelmintic compound may be abamectin, ivermectin, moxidectin, doramectin or eprinomectin.

Advantageously, the anthelmintic compound may be present in an amount of about 1% by weight of the formulation.

Advantageously, the vegetable oil may be soya bean oil, sesame oil or corn oil.

Advantageously, the first co-solvent may be benzyl alcohol.

More advantageously, the benzyl alcohol may be present in an amount of between about 17 and 25% w/v.

Advantageously, the castor oil may be present in an amount of between about 4 and 25% w/v. Most advantageously, the castor oil may be present in an amount of about 5% w/v.

In a second aspect the invention relates to an anti-parasitic formulation which may include one or more macrocyclic lactone anthelmintic compounds, together with a vegetable oil, wherein the vegetable oil may be soya bean oil, sesame oil or corn oil, one or more alcohol co-solvent having four or more carbon atoms, and castor oil, wherein the co-solvent may be present in an amount of at least 17% by weight and the castor oil may be present in an amount of 25% by weight or less.

Advantageously, the anthelmintic compound may comprise abamectin, ivermectin, moxidectin, doramectin and eprinomectin.

Advantageously, the anthelmintic compound may be present in an amount of about 1% by weight of the formulation.

Advantageously, the first co-solvent may be benzyl alcohol.

More advantageously, the benzyl alcohol may be present in an amount of between about 17 and 25% w/v.

Advantageously, the castor oil may be present in an amount of between about 4 and 25% w/v. Most advantageously, the castor oil may be present in an amount of about 5% w/v.

In a further aspect the invention relates to a method of treating livestock to prevent or decrease the level of infection by endo- and/or ecto-parasites, which may comprise administering to the livestock an anti-parasitic formulation as described herein.

Advantageously, the formulation may be formulated for topical or pour-on administration to the animal.

Advantageously, the pour-on formulation may be administered in an amount of 500 mcg of the anthelmintic compound per kg of the animal's live weight.

More advantageously, the pour-on formulation may be administered at a dosage rate of 1 ml per 20 kg of the animal's live weight.

The formulation may also be formulated for injectable administration to the animal.

Advantageously, the injectable formulation may be administered in an amount of 200 mcg of the anthelmintic compound per kg of the animal's live weight.

More advantageously, the injectable formulation may be administered at a dosage rate of 1 ml per 50 kg of the animal's live weight.

The formulation may also be formulated for oral administration to the animal.

Advantageously, the oral formulation may be administered in an amount of 200 mcg of the anthelmintic compound per kg of the animal's live weight.

More advantageously, the oral formulation may be administered at a dosage rate of 1 ml per 5 kg of the animal's live weight.

It is noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the invention.

These and other embodiments are disclosed or are obvious from and encompassed by, the following Detailed Description.

### DETAILED DESCRIPTION

In a first aspect the invention relates an anti-parasitic formulation which may comprise: (a) one or more macrocyclic lactone anthelmintic compounds, (b) one or more alcohol co-solvents, (c) castor oil present, and (d) a vegetable oil wherein the vegetable oil is an oil other than castor oil.

In one embodiment, the one or more alcohol co-solvent(s) is an alcohol having four or more carbon atoms. In another embodiment, the alcohol co-solvent or mixture of co-solvents is present in an amount of at least 17% by weight.

In another embodiment, the castor oil is present in an amount of 25% by weight or less.

In a second aspect the invention relates to an anti-parasitic formulation which may include an anthelmintic compound which may be selected from the class of macrocyclic lactones, together with a vegetable oil selected from the group which may comprise soya bean oil, sesame oil and corn oil, a co-solvent which may be selected from the group consisting of alcohols having four or more carbon atoms, and castor oil, wherein the co-solvent may be present in an amount of at least 17% by weight and the castor oil may be present in an amount of 25% by weight or less.

Macrolide anthelmintic compounds are known for treating endo- and ectoparasite infections in warm-blooded animals. Compounds that belong to this class of agents include the avermectin and milbemycin series of compounds. These compounds are potent antiparasitic agents against a wide range of internal and external parasites. Avermectins and milbemycins share the same common 16-membered macrocyclic lactone ring; however, milbemycins do not possess the disaccharide substituent on the 13-position of the lactone ring. In addition to treating parasitic insects, such as flies, avermectins and milbemycins are used to treat endoparasites, e.g., round worm infections, in warm-blooded animals.

The avermectin and milbemycin series of compounds either are natural products or are semi-synthetic derivatives. The natural product avermectins are disclosed in U.S. Pat. No. 4,310,519 to Albers-Schonberg, et al., and the 22,23-dihydro avermectin compounds are disclosed in Chabala, et al., U.S. Pat. No. 4,199,569. For a general discussion of avermectins, which include a discussion of their uses in humans and animals, see “Ivermectin and Abamectin,” W. C. Campbell, ed., Springer-Verlag, New York (1989). Naturally occurring milbemycins are described in Aoki et al., U.S. Pat. No. 3,950,360 as well as in the various references cited in “The Merck Index” 12^{th} ed., S. Budavari, Ed., Merck & Co., Inc. Whitehouse Station, New Jersey (1996). Semisynthetic derivatives of these classes of compounds are well known in the art and are described, for example, in U.S. Pat. No. 5,077,308, U.S. Pat. No. 4,859,657, U.S. Pat. No. 4,963,582, U.S. Pat. No. 4,855,317, U.S. Pat. No. 4,871,719, U.S. Pat. No. 4,874,749, U.S. Pat. No. 4,427,663, U.S. Pat. No. 4,310,519, U.S. Pat. No. 4,199,569, U.S. Pat. No. 5,055,596, U.S. Pat. No. 4,973,711, U.S. Pat. No. 4,978,677, and U.S. Pat. No. 4,920,148. All these documents are herein incorporated by reference.

Advantageously, the anthelmintic compound may be selected from the group which may comprise abamectin, ivermectin, moxidectin, doramectin and eprinomectin. Although abamectin is used as the active ingredient in the preferred formulations described herein, it is envisaged that other macrocyclic lactones including but not limited to ivermectin, doramectin, eprinomectin, selamectin and moxidectin could be used in the formulations.

The macrolide anthelmintic compounds contemplated in this invention are also well known to a practitioner of this area. These compounds include avermectins and milbemycins, some of which are discussed above. Non-limiting examples of compounds belonging to this class are represented by the following structure:

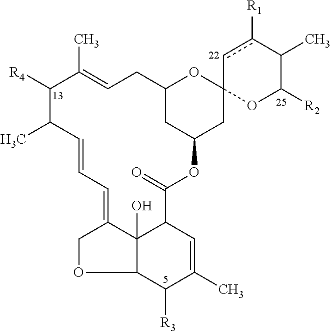

where the broken line indicates a single or a double bond at the 22,23-positions;

R₁ is hydrogen or hydroxy provided that R₁ is present only when the broken line indicates a single bond;

R₂ is alkyl of from 1 to 6 carbon atoms or alkenyl of from 3 to 6 carbon atoms or cycloalkyl of from 3 to 8 carbon atoms;

R₃ is hydroxy, methoxy or ═NOR₅ where R₅ is hydrogen or lower alkyl; and

R₄ is hydrogen, hydroxy or

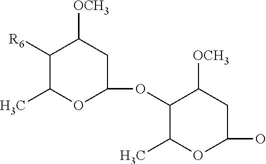

where R₆ is hydroxy, amino, mono-or di-lower alkylamino or lower alkanoylamino.

The preferred compounds are avermectin Bla/Blb (abamectin), 22,23-dihydro avermectin Bla/Blb (ivermectin) and the 4″-acetylamino-5-ketoximino derivative of avermectin Bla/Blb. Both abamectin and ivermectin are approved as broad spectrum antiparasitic agents. The structures of abamectin and ivermectin are as follows:

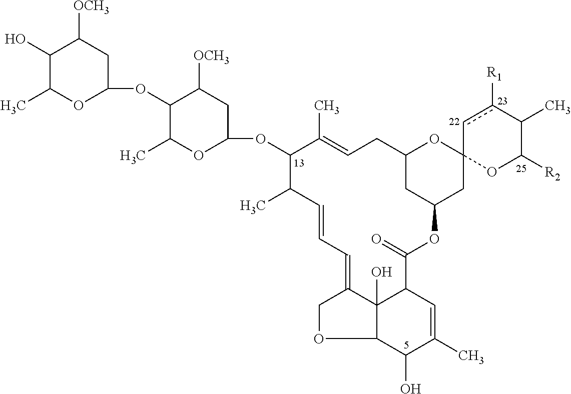

wherein for abamectin the broken line represents a double bond and R₁ is not present and for ivermectin the double bond represents a single bond and R₁ is hydrogen; and R₂ is isopropyl or sec-butyl.

The 4″-acetyl amino-5-ketoximino derivatives of avermectin Bla/Blb has the following structural formula:

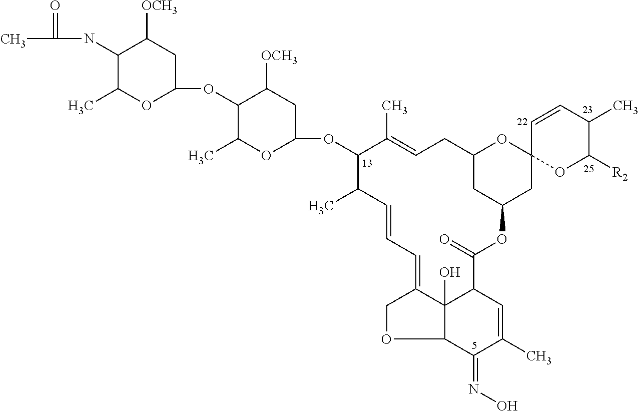

where R₂ is isopropyl or sec-butyl.

The avermectin products are generally prepared as a mixture of at least 80% of the compound where R₂ is sec-butyl and no more than 20% of the compound where R₂ is isopropyl.

Other preferred avermectins, include ememectin, epinomectin and doramectin. Doramectin is disclosed in U.S. Pat. No. 5,089,490 and EP 214 738. This compound has the following structure:

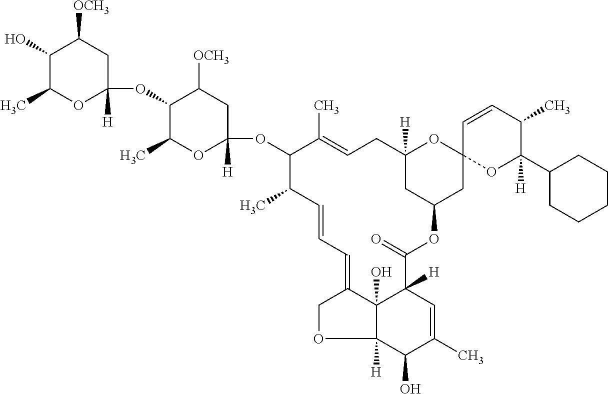

In the present formulations, ivermectin is especially preferred.

A representative structure for a milbemycin is that for milbemycin α₁:

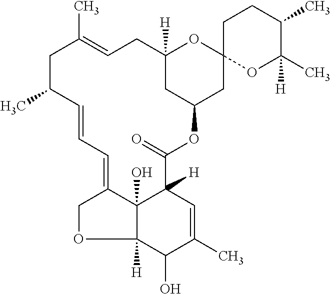

An especially preferred milbemycin is moxidectin, whose structure is as follows:

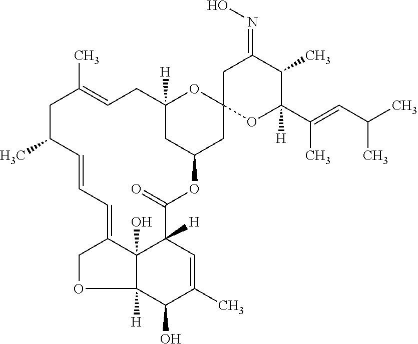

The compound is disclosed in U.S. Pat. No. 5,089,490.

The monosaccharide avermectin derivatives are also preferred especially where an oxime substitution is present on the 5-position of the lactone ring. Such compounds are described, for example, in EP 667,054. Selamectin is an especially preferred compound of this class of derivatives.

This application contemplates all pharmaceutically or veterinary acceptable acid or base salts forms of the anthelmintic compounds, where applicable. The term “acid” contemplates all pharmaceutically or veterinary acceptable inorganic or organic acids. Inorganic acids include mineral acids such as hydrohalic acids, such as hydrobromic and hydrochloric acids, sulfuric acids, phosphoric acids and nitric acids. Organic acids include all pharmaceutically or veterinary acceptable aliphatic, alicyclic and aromatic carboxylic acids, dicarboxylic acids tricarboxylic acids and fatty acids. Preferred acids are straight chain or branched, saturated or unsaturated C₁-C₂₀ aliphatic carboxylic acids, which are optionally substituted by halogen or by hydroxyl groups, or C₆-C₁₂ aromatic carboxylic acids. Examples of such acids are carbonic acid, formic acid, fumaric acid, acetic acid, propionic acid, isopropionic acid, valeric acid, α-hydroxy acids, such as glycolic acid and lactic acid, chloroacetic acid, benzoic acid, methane sulfonic acid, and salicylic acid. Examples of dicarboxylic acids include oxalic acid, malic acid, succinic acid, tataric acid and maleic acid. An example of a tricarboxylic acid is citric acid. Fatty acids include all pharmaceutically or veterinary acceptable saturated or unsaturated aliphatic or aromatic carboxylic acids having 4 to 24 carbon atoms. Examples include butyric acid, isobutyric acid, sec-butyric acid, lauric acid, palmitic acid, stearic acid, oleic acid, linoleic acid, linolenic acid, and phenylsteric acid. Other acids include gluconic acid, glycoheptonic acid and lactobionic acid.

The term “base” contemplates all pharmaceutically or veterinary acceptable inorganic or organic bases. Such bases include, for example, the alkali metal and alkaline earth metal salts, such as the lithium, sodium, potassium, magnesium or calcium salts. Organic bases include the common hydrocarbyl and heterocyclic amine salts, which include, for example, the morpholine and piperidine salts.

The ester and amide derivatives of these compounds, where applicable, are also contemplated. Specific compounds which belong to this class of macrolide antiparasitic agents are well known to the practitioner of this art.

Advantageously, the anthelmintic compound may be present in an amount of about 0.1% to about 10%, about 0.2% to about 9%, about 0.3% to about 8%, about 0.4% to about 7%, about 0.5% to about 6%, about 0.6% to about 5%, about 0.7% to about 4%, about 0.8% to about 3%, about 0.8% to about 2%, about 0.9% to about 1.5%, advantageously, about 1% by weight of the formulation.

In some embodiments, the formulations of the present invention may further comprise one or more additional active ingredient, such as additional parasiticide or an anti-parasitic agent, which includes, but is not limited to other insect growth regulator Ouvenile hormone mimics or CSI), morantel, pyrantel, febrantel, benzimidizole, such as thiabendazole or cambendazole, nodulisporic acid derivative, 1-N-arylpyrazole and any combinations thereof. It is known in the art that it is sometimes possible to combine various parasiticides in order to broaden the antiparasitical spectrum.

In one embodiment, the present invention involves the use of a co-solvent, which may advantageously be benzyl alcohol.

More advantageously, the alcohol solvent may be present in an amount of between about 1 and about 40%, about 10 and 32%, about 11 and 31%, about 12 and 30%, about 13 and 29%, about 14 and 28%, about 15 and 27%, about 16 and 26%, advantageously about 17 and 25% w/v.

Although benzyl alcohol is used in the preferred formulations described herein, it is envisaged that one or more other alcohol solvents, including other aliphatic or aromatic alcohols may be utilized in the inventive formulations. In some embodiments, the formulations advantageously comprise aromatic alcohols, having four or more carbon atoms in place of or in addition to benzyl alcohol. For example, ethyl benzyl alcohol, phenethyl alcohol and other aromatic monohydric alcohols, or a combination thereof, may be used in the formulations. In other embodiments, mixtures of alcohol solvents may be used in the formulations.

In other embodiments, an alcohol solvent may be combined with another pharmaceutically acceptable solvent known in the art in the inventive formulations.

The present invention involves the use of a vegetable oil which may be selected from the group which may comprise soya bean oil, sesame oil and corn oil.

Although soya bean oil is used in the preferred formulations described herein, it is envisaged that other vegetable oils (other than castor oil) could be used in the formulations in place of soya bean oil, for example, sesame oil, corn oil and the like.

The vegetable oil may be a major oil, a nut oil, an oil from melon and gourd seeds, a food supplement or a multipurpose oil. Major oils include, but are not limited to, coconut oil, corn oil, cottonseed oil, olive oil, palm oil, peanut oil, rapeseed oil (including canola oil), safflower oil, sesame oil, soybean oil or sunflower oil. Nut oils include, but are not limited to, almond oil, cashew oil, hazelnut oil, macadamia oil, mongongo nut oil, pecan oil, pistachio oil or walnut oil. Oils from melon and gourd seeds include, but are not limited to, bottle gourd oil, buffalo gourd oil, pumpkin seed oil or watermelon seed oil. Food supplement oils include, but are not limited to, acai oil, blackcurrant seed oil, borage seed oil or evening primrose oil. Other edible oils include, but are not limited to, amaranth oil, apricot oil, apple seed oil, argan oil, artichoke oil, avocado oil, babassu oil, ben oil, Borneo tallow nut oil, Cape Chestnut oil, cocoa butter, carob pod oil, cohune oil, coriander seed oil, dika oil, false flax oil, flax seed oil, grape seed oil, hemp oil, kapok seed oil, lallemantia oil, marula oil, meadowfoam seed oil, mustard oil, nutmeg butter, okra seed oil, papaya seed oil, perilla seed oil, pequi oil, pine nut oil, poppyseed oil, prune kernel oil, quinoa oil, ramtil oil, rice bran oil, royle oil, Sacha Inchi oil, tea oil, thistle oil, tomato seed oil or wheat germ oil. Multipurpose oils include, but are not limited to, coconut oil, corn oil, cottonseed oil, false flax oil, hemp oil, mustard oil, palm oil, peanut oil, radish oil, rapeseed oil, ramtil oil, rice bran oil, safflower oil, soybean oil, sunflower oil or tung oil.

The present invention involves the use of a castor oil. Advantageously, the castor oil may be present in an amount of between about 1 and about 30%, about 4 and 25%, about 4.25 and 20%, about 4.5 and 15%, about 4.75 and 10% w/v. Most advantageously, the castor oil may be present in an amount of about 5% w/v.

Other oil soluble actives may also be added to the formulations, for example, oil soluble vitamins.

Additionally, the inventive formulations may contain other inert ingredients such as antioxidants, preservatives, or pH stabilizers. These compounds are well known in the formulation art. Antioxidant such as an alpha tocopheral, ascorbic acid, ascrobyl palmitate, fumeric acid, malic acid, sodium ascorbate, sodium metabisulfate, n-propyl gallate, BHA (butylated hydroxy anisole), BHT (butylated hydroxy toluene) monothioglycerol and the like, may be added to the present formulation. The antioxidants are generally added to the formulation in amounts of from about 0.01 to about 2.0%, based upon total weight of the formulation, with about 0.05 to about 1.0% being especially preferred. Preservatives, such as the parabens (methylparaben and/or propylparaben), are suitably used in the formulation in amounts ranging from about 0.01 to about 2.0%, with about 0.05 to about 1.0% being especially preferred. Other preservatives include benzalkonium chloride, benzethonium chloride, benzoic acid, benzyl alcohol, bronopol, butylparaben, cetrimide, chlorhexidine, chlorobutanol, chlorocresol, cresol, ethylparaben, imidurea, methylparaben, phenol, phenoxyethanol, phenylethyl alcohol, phenylmercuric acetate, phenylmercuric borate, phenylmercuric nitrate, potassium sorbate, sodium benzoate, sodium propionate, sorbic acid, thimerosal, and the like. Preferred ranges for these compounds include from about 0.01 to about 5%.

Colorants may be added to the inventive formulations. Colorants contemplated by the present invention are those commonly known in the art. Specific colorants include, for example, dyes, an aluminum lake, caramel, colorant based upon iron oxide or a mixture of any of the foregoing. Especially preferred are organic dyes and titanium dioxide. Preferred ranges include from about 0.5% to about 25%.

Compounds which stabilize the pH of the formulation are also contemplated. Again, such compounds are well known to a practitioner in the art as well as how to use these compounds. Buffering systems include, for example, systems selected from the group consisting of acetic acid/acetate, malic acid/malate, citric acid/citrate, tataric acid/tartrate, lactic acid/lactate, phosphoric acid/phosphate, glycine/glycimate, tris, glutamic acid/glutamates and sodium carbonate. Preferred ranges for pH include from about 4 to about 6.5.

The formulations of the present invention may include further excipients such as pharmaceutically acceptable lubricant or solubilizer selected from the group consisting of neutral oils of esters of saturated coconut and palm oils, corn oil, mineral oils, castor oil, hydrogenated castor oil, oxygenated castor oil, fractionated coconut oil, peanut oil, sesame oil, a surfactant and mixtures thereof. The presence of a solubilizer is to enhance the solubility or bioavailability of the pharmaceutically active material. A solubilizer may be used as a wetting agent for the pharmaceutically active material, or can also be used as a surfactant or can also be used as a lubricant. Solubilizers can be water or oil based. Non-limiting examples of solubilizers include neutral oils of esters of saturated coconut and palm oils (Miglyol® neutral oils, e.g. Miglyol® 810, 812, 818, 829, and 840, castor oil based surfactants (e.g. Sufactol® 318 (PEG-5) or Surfactol® 365 (PEG-40), corn oils, mineral oils, peanut oil, sesame oil, fractionated oils and surfactols.

The surfactant can be anionic, cationic, nonionic or amphoteric. Non limiting examples of anionic surfactants are alkaline stearates, such as sodium, potassium or ammonium stearate; calcium stearate or triethanolamine stearate; sodium abietate; alkyl sulphates, such as sodium lauryl sulphate and sodium cetyl sulphate; sodium dodecylbenzenesulphonate or sodium dioctyl sulphosuccinate; or fatty acids, such as those derived from coconut oil. Example of cationic surfactants, such as water-soluble quaternary ammonium salts of formula N⁺R′R″R′″R″″Y⁻, in which the R groups are identical or different optionally hydroxylated hydrocarbon groups and Y⁻ is an anion of a strong acid, such as halide, sulphate and sulphonate anions; or cetyltrimethylammonium bromide and the like.

Non limiting examples of non-ionic surfactants are polyoxyethylenated esters of sorbitan, in particular polysorbate 80 (Tween® 80), or polyoxyethylenated alkyl ethers; polyethylene glycol stearate, polyoxyethylenated derivatives of castor oil, such as PEG-5 to PEG-100 hydrogenated castor oil and in particular PEG-40 hydrogenated castor oil, polyglycerol esters, polyoxyethylenated fatty alcohols, polyoxyethylenated fatty acids or copolymers of ethylene oxide and of propylene oxide and glyceryl monostearate.

Non-limiting examples of amphoteric surfactants are substituted lauryl compounds of betaine.

Crystallization inhibitors which can be used in topical formulations in the present invention include, but are not limited to:
polyvinylpyrrolidone (PVP), polyvinyl alcohols, polyvidone, copolymers of vinyl acetate and of vinylpyrrolidone, polyethylene glycols, benzyl alcohol, mannitol, glycerol, sorbitol or polyoxyethylenated esters of sorbitan; lecithin or sodium carboxymethylcellulose; or acrylic derivatives, such as methacrylates and others,
anionic surfactants, such as alkaline stearates, in particular sodium, potassium or ammonium stearate; calcium stearate or triethanolamine stearate; sodium abietate; alkyl sulphates, in particular sodium lauryl sulphate and sodium cetyl sulphate; sodium dodecylbenzenesulphonate or sodium dioctyl sulphosuccinate; or fatty acids, in particular those derived from coconut oil,
cationic surfactants, such as water-soluble quaternary ammonium salts of formula N⁺R′R″R′″R″″Y⁻, in which the R radicals are identical or different optionally hydroxylated hydrocarbon radicals and Y⁻ is an anion of a strong acid, such as halide, sulphate and sulphonate anions; cetyltrimethylammonium bromide is one of the cationic surfactants which can be used,
amine salts of formula N⁺R′R″R′″, in which the R radicals are identical or different optionally hydroxylated hydrocarbon radicals; octadecylamine hydrochloride is one of the cationic surfactants which can be used,
non-ionic surfactants, such as optionally polyoxyethylenated esters of sorbitan, in particular Polysorbate 80, or polyoxyethylenated alkyl ethers; polyethylene glycol stearate, polyoxyethylenated derivatives of castor oil, polyglycerol esters, polyoxyethylenated fatty alcohols, polyoxyethylenated fatty acids or copolymers of ethylene oxide and of propylene oxide,
amphoteric surfactants, such as substituted lauryl compounds of betaine,
or advantageously a mixture of at least two of the compounds listed above.
   In a particularly advantageous embodiment, a crystallization inhibitor pair will be used.

Such pairs include, for example, the combination of a film-forming agent of polymeric type and of a surface-active agent. These agents will be selected in particular from the compounds mentioned above as crystallization inhibitor.

Particularly advantageous film-forming agents of polymeric type include:
the various grades of polyvinylpyrrolidone (PVP),
polyvinyl alcohols, and
copolymers of vinyl acetate and of vinylpyrrolidone.

Especially advantageous surface-active agents, include those made of non-ionic surfactants, advantageously polyoxyethylenated esters of sorbitan and in particular the various grades of polysorbate, for example Polysorbate 80.

The film-forming agent and the surface-active agent can in particular be incorporated in similar or identical amounts within the limit of the total amounts of crystallization inhibitor mentioned elsewhere.

The pair thus constituted secures, in a noteworthy way, the objectives of absence of crystallization on the coat and of maintenance of the cosmetic appearance of the fur, that is to say without a tendency towards sticking or towards a sticky appearance, despite the high concentration of active material.

The crystallization inhibitor can in particular be present in a proportion of about 1 to about 20% (W/V), advantageously of about 2 or about 5 to about 15%.

The thickeners contemplated by this invention are well known to a practitioner of this art. Compounds which function as thickeners include, for example, povidone, maltodextrin, polydextrate, EMDEX (dextrates), carboxypolymethylene (Carbomer®), polyethylene glycol and celluloses, such as hydroxypropyl celluloses. An especially advantageous thickener is povidone. Thickeners may be present in amounts of from about 0.1% to about 25%.

Opacifiers may be added to absorb and/or reflect certain light and/or energy of certain wavelengths and may thus enhance the stability of the formulations. Opacifiers include, for example, zinc oxide or titanium dioxide. These compounds are well known to practitioners of this art.

The inventive topical formulations may also contain penetration enhancers, such as dimethylacetamide, Transcutol®, DMSO or dimethyl isorbide, or chelating agents. Penetration enhancers are used in small amounts, amounts that are of such quantity that they will not dissolve the actives.

In a further aspect the invention relates to a method of treating livestock to prevent or decrease the level of infection by endo- and/or ecto-parasites, which may comprise administering to the livestock an effective amount of an anti-parasitic formulation as described herein.

The invention is also directed toward a method of treating an animal, advantageously a live stock animal, against ectoparasitic infection by administering an ectoparasiticidally effective amount of the composition of the invention. Mammals which can be treated include but are not limited to humans, cats, dogs, cattle, chickens, cows, deer, goats, horses, llamas, pigs, sheep and yaks. In one embodiment of the invention, the mammals treated are humans, cats or dogs.

In another embodiment for treatment against ectoparasites, the ectoparasite one or more insect or arachnid including those of the genera Ctenocephalides, Rhipicephalus, Dermacentor, Ixodes, Boophilus, Ambylomma, Haemaphysalis, Hyalomma, Sarcoptes, Psoroptes, Otodectes, Chorioptes, Hypoderma, Damalinia, Linognathus, Haematopinus, Solenoptes, Trichodectes, and Felicola.

In another embodiment for the treatment against ectoparasites, the ectoparasite is from the genera Ctenocephalides, Rhipicephalus, Dermacentor, Ixodes and/or Boophilus. The ectoparasites treated include but are not limited to fleas, ticks, mites mosquitoes, flies, lice, blowfly and combinations thereof. Specific examples include but are not limited to cat and dog fleas (Ctenocephalides felis, Ctenocephalides sp. and the like), ticks (Rhipicephalus sp., Ixodes sp., Dermacentor sp., Amblyoma sp. and the like), and mites (Demodex sp., Sarcoptes sp., Otodectes sp. and the like), lice (Trichodectes sp., Cheyletiella sp., Lignonathus sp., and the like), mosquitoes (Aedes sp., Culux sp., Anopheles sp., and the like) and flies (Hematobia sp., Musca sp., Stomoxys sp., Dematobia sp., Coclyomia sp., and the like). In yet another embodiment for the treatment against ectoparasites, the ectoparasite is a flea and/or tick.

Additional examples of ectoparasites include but are not limited to the tick genus Boophilus, especially those of the species microplus (cattle tick), decoloratus and anulatus; myiases such as Dermatobia hominis (known as Berne in Brazil) and Cochlyomia hominivorax (greenbottle); sheep myiases such as Lucilia sericata, Lucilia cuprina (known as blowfly strike in Australia, New Zealand and South Africa). Flies proper, namely those whose adult constitutes the parasite, such as Haematobia irritans (horn fly); lice such as Linognathus vitulorum, etc.; and mites such as Sarcoptes scabici and Psoroptes ovis. The above list is not exhaustive and other ectoparasites are well known in the art to be harmful to animals and humans. These include, for example migrating dipterous larvae.

When an anthelmintic agent is added to the composition of the invention, the composition can also be used to treat against endoparasites such as those helminths selected from the group consisting of Anaplocepheda, Ancylostoma, Anecator, Ascaris, Capillaria, Cooperia, Dipyllidinum, Dirofilaria, Echinococcus, Enterobius, Fasciola, Haemonchus, Oesophagostumum, Ostertagia, Toxocara, Strongyloides, Toxascaris, Trichinella, Trichuris, and Trichostrongylus.

In addition with or without the addition of other pesticidal agents are added the composition of the invention can also be used to treat other pests which include but are not limited to pests:
(1) from the order Isopoda, for example Oniscus asellus, Armadillidium vulgare and Porcellio scaber;
(2) from the order Diplopoda, for example Blaniulus guttulatus;
(3) from the order Chilopoda, for example Geophilus carpophagus and Scutigera spp.;
(4) from the order Symphyla, for example Scutigerella immaculata;
(5) from the order Thysanura, for example Lepisma saccharina;
(6) from the order Collembola, for example Onychiurus armatus;
(7) from the order Orthoptera, for example Acheta domesticus, Gryllotalpa spp., Locusta migratoria migratorioides, Melanoplus spp. and Schistocerca gregaria;
(8) from the order Blattaria, for example Blatta orientalis, Periplaneta americana, Leucophaea maderae and Blattella germanica;
(9) from the order Dermaptera, for example Forficula auricularia;
(10) from the order Isoptera, for example Reticulitermes spp.;
(11) from the order Phthiraptera, for example Pediculus humanus corporis, Haematopinus spp., Linognathus spp., Trichodectes spp. and Damalinia spp.;
(12) from the order Thysanoptera, for example Hercinothrips femoralis, Thrips tabaci, Thrips palmi and Frankliniella accidentalis;
(13) from the order Heteroptera, for example Eurygaster spp., Dysdercus intermedius, Piesma quadrata, Cimex lectularius, Rhodnius prolixus and Triatoma spp.;
(14) from the order Homoptera, for example Aleurodes brassicae, Bemisia tabaci, Trialeurodes vaporariorum, Aphis gossypii, Brevicoryne brassicae, Cryptomyzus ribis, Aphis fabae, Aphis pomi, Eriosoma lanigerum, Hyalopterus arundinis, Phylloxera vastatrix, Pemphigus spp., Macrosiphum avenae, Myzus spp., Phorodon humuli, Rhopalosiphum padi, Empoasca spp., Euscelis bilobatus, Nephotettix cincticeps, Lecanium corni, Saissetia oleae, Laodelphax striatellus, Nilaparvata lugens, Aonidiella aurantii, Aspidiotus hederae, Pseudococcus spp. and Psylla spp.;
(15) from the order Lepidoptera, for example Pectinophora gossypiella, Bupalus piniarius, Cheimatobia brumata, Lithocolletis blancardella, Hyponomeuta padella, Plutella xylostella, Malacosoma neustria, Euproctis chrysorrhoea, Lymantria spp., Bucculatrix thurberiella, Phyllocnistis citrella, Agrotis spp., Euxoa spp., Feltia spp., Earias insulana, Heliothis spp., Helicoverpa spp., Mamestra brassicae, Panolis flammea, Spodoptera spp., Trichoplusia ni, Carpocapsa pomonella, Pieris spp., Chilo spp., Pyrausta nubilalis, Ephestia kuehniella, Galleria mellonella, Tineola bisselliella, Tinea pellionella, Hofmannophila pseudospretella, Cacoecia podana, Capua reticulana, Choristoneurafumiferana, Clysia ambiguella, Homona magnanima, Tortrix viridana and Cnaphalocerus spp.;
(16) from the order Coleoptera, for example Anobiur punctatum, Rhizopertha dominica, Bruchidius obtectus, Acanthoscelides obtectus, Hylotrupes bajulus, Agelastica alni, Leptinotarsa decerlineata, Phaedon cochleariae, Diabrotica spp., Psylliodes chrysocephala, Epilachna varivestis, Atomaria spp., Oryzaephilus surinamensis, Anthonomus spp., Sitophilus spp., Otiorrhynchus sulcatus, Cosmopolites sordidus, Ceuthorrhynchus assimilis, Hypera postica, Dermestes spp., Trogoderma spp., Anthrenus spp., Attagenus spp., Lyctus spp., Meligethes aeneus, Ptinus spp., Niptus hololeucus, Gibbiur psylloides, Tribolium spp., Tenebrio molitor, Agriotes spp., Conoderus spp., Melolontha melolontha, Amphimallon solstitialis and Costelytra zealandica;
(17) from the order Hymenoptera, for example Diprion spp., Hoplocampa spp., Lasius spp., Monomorium pharaonis and Vespa spp.;
(18) from the order Diptera, for example Aedes spp., Anopheles spp., Culex spp., Drosophila melanogaster, Musca spp., Fannia spp., Calliphora erythrocephala, Lucilia spp., Chrysomyia spp., Cuterebra spp., Gastrophilus spp., Hyppobosca spp., Stomoxys spp., Oestrus spp., Hypoderma spp., Tabanus spp., Tannia spp., Bibio hortulanus, Oscinella frit, Phorbia spp., Pegomyia hyoscyami, Ceratitis capitata, Dacus oleae, Tipula paludosa, Hylemyia spp. and Liriomyza spp.;
(19) from the order Siphonaptera, for example Xenopsylla cheopis and Ceratophyllus spp.;

(20) from the class of arachnids, for example Scorpio maurus, Latrodectus mactans, Acarus siro, Argas spp., Ornithodoros spp., Dermanyssus gallinae, Eriophyes ribis, Phyllocoptruta oleivora, Boophilus spp., Rhipicephalus spp., Amblyomma spp., Hyalomma spp., Ixodes spp., Psoroptes spp., Chorioptes spp., Sarcoptes spp., Tarsonemus spp., Bryobia praetiosa, Panonychus spp., Tetranychus spp., Hemitarsonemus spp. and Brevipalpus spp.; and
(21) the plant-parasitic nematodes, for example, Pratylenchus spp., Radopholus similis, Ditylenchus dipsaci, Tylenchulus semipenetrans, Heterodera spp., Globodera spp., Meloidogyne spp., Aphelenchoides spp., Longidorus spp., Xiphinema spp., Trichodorus spp. and Bursaphelenchus spp.

The active compounds according to the invention, in combination with good plant tolerance and favorable toxicity to warm-blooded animals and being tolerated well by the environment, are suitable for protecting plants and plant organs, for increasing the harvest yields, for improving the quality of the harvested material and for controlling animal pests, in particular insects, arachnids, helminths, nematodes and molluscs, which are encountered in agriculture, in horticulture, in animal husbandry, in forests, in gardens and leisure facilities, in the protection of stored products and of materials, and in the hygiene sector. They may be preferably employed as plant protection agents. They are active against normally sensitive and resistant species and against all or some stages of development. The abovementioned pests include:

From the order of the Anoplura (Phthiraptera), for example, Damalinia spp., Haematopinus spp., Linognathus spp., Pediculus spp., Trichodectes spp.

From the class of the Arachnida, for example, Acarus siro, Aceria sheldoni, Aculops spp., Aculus spp., Amblyomma spp., Argas spp., Boophilus spp., Brevipalpus spp., Bryobia praetiosa, Chorioptes spp., Dermanyssus gallinae, Eotetranychus spp., Epitrimerus pyri, Eutetranychus spp., Eriophyes spp., Hemitarsonemus spp., Hyalomma spp., Ixodes spp., Latrodectus mactans, Metatetranychus spp., Oligonychus spp., Ornithodoros spp., Panonychus spp., Phyllocoptruta oleivora, Polyphagotarsonemus latus, Psoroptes spp., Rhipicephalus spp., Rhizoglyphus spp., Sarcoptes spp., Scorpio maurus, Stenotarsonemus spp., Tarsonemus spp., Tetranychus spp., Vasates lycopersici.

From the class of the Bivalva, for example, Dreissena spp.

From the order of the Chilopoda, for example, Geophilus spp., Scutigera spp.

From the order of the Coleoptera, for example, Acanthoscelides obtectus, Adoretus spp., Agelastica alni, Agriotes spp., Amphimallon solstitialis, Anobium punctatum, Anoplophora spp., Anthonomus spp., Anthrenus spp., Apogonia spp., Atomaria spp., Attagenus spp., Bruchidius obtectus, Bruchus spp., Ceuthorhynchus spp., Cleonus mendicus, Conoderus spp., Cosmopolites spp., Costelytra zealandica, Curculio spp., Cryptorhynchus lapathi, Dermestes spp., Diabrotica spp., Epilachna spp., Faustinus cubae, Gibbium psylloides, Heteronychus arator, Hylamorpha elegans, Hylotrupes bajulus, Hypera postica, Hypothenemus spp., Lachnosterna consanguinea, Leptinotarsa decemlineata, Lissorhoptrus oryzophilus, Lixus spp., Lyctus spp., Meligethes aeneus, Melolontha melolontha, Migdolus spp., Monochamus spp., Naupactus xanthographus, Niptus hololeucus, Oryctes rhinoceros, Oryzaephilus surinamensis, Otiorrhynchus sulcatus, Oxycetonia jucunda, Phaedon cochleariae, Phyllophaga spp., Popillia japonica, Premnotrypes spp., Psylliodes chrysocephala, Ptinus spp., Rhizobius ventralis, Rhizopertha dominica, Sitophilus spp., Sphenophorus spp., Sternechus spp., Symphyletes spp., Tenebrio molitor, Tribolium spp., Trogoderma spp., Tychius spp., Xylotrechus spp., Zabrus spp.

From the order of the Collembola, for example, Onychiurus armatus.

From the order of the Dermaptera, for example, Forficula auricularia.

From the order of the Diplopoda, for example, Blaniulus guttulatus.

From the order of the Diptera, for example, Aedes spp., Anopheles spp., Bibio hortulanus, Calliphora erythrocephala, Ceratitis capitata, Chrysomyia spp., Cochliomyia spp., Cordylobia anthropophaga, Culex spp., Cuterebra spp., Dacus oleae, Dermatobia hominis, Drosophila spp., Fannia spp., Gastrophilus spp., Hylemyia spp., Hyppobosca spp., Hypoderma spp., Liriomyza spp., Lucilia spp., Musca spp., Nezara spp., Oestrus spp., Oscinella frit, Pegomyia hyoscyami, Phorbia spp., Stomoxys spp., Tabanus spp., Tannia spp., Tipula paludosa, Wohlfahrtia spp.

From the class of the Gastropoda, for example, Arion spp., Biomphalaria spp., Bulinus spp., Deroceras spp., Galba spp., Lymnaea spp., Oncomelania spp., Succinea spp.

From the class of the helminths, for example, Ancylostoma duodenale, Ancylostoma ceylanicum, Acylostoma braziliensis, Ancylostoma spp., Ascaris lubricoides, Ascaris spp., Brugia malayi, Brugia timori, Bunostomum spp., Chabertia spp., Clonorchis spp., Cooperia spp., Dicrocoelium spp, Dictyocaulusfilaria, Diphyllobothrium latum, Dracunculus medinensis, Echinococcus granulosus, Echinococcus multilocularis, Enterobius vermicularis, Faciola spp., Haemonchus spp., Heterakis spp., Hymenolepis nana, Hyostrongulus spp., Loa Loa, Nematodirus spp., Oesophagostomum spp., Opisthorchis spp., Onchocerca volvulus, Ostertagia spp., Paragonimus spp., Schistosomen spp., Strongyloides fuelleborni, Strongyloides stercoralis, Stronyloides spp., Taenia saginata, Taenia solium, Trichinella spiralis, Trichinella nativa, Trichinella britovi, Trichinella nelsoni, Trichinella pseudopsiralis, Trichostrongulus spp., Trichuris trichuria, Wuchereria bancrofti.

It is furthermore possible to control protozoa, such as Eimeria.

From the order of the Heteroptera, for example, Anasa tristis, Antestiopsis spp., Blissus spp., Calocoris spp., Campylomma livida, Cavelerius spp., Cimex spp., Creontiades dilutus, Dasynus piperis, Dichelops furcatus, Diconocoris hewetti, Dysdercus spp., Euschistus spp., Eurygaster spp., Heliopeltis spp., Horcias nobilellus, Leptocorisa spp., Leptoglossus phyllopus, Lygus spp., Macropes excavatus, Miridae, Nezara spp., Oebalus spp., Pentomidae, Piesma quadrata, Piezodorus spp., Psallus seriatus, Pseudacysta persea, Rhodnius spp., Sahlbergella singularis, Scotinophora spp., Stephanitis nashi, Tibraca spp., Triatoma spp.

From the order of the Homoptera, for example, Acyrthosipon spp., Aeneolamia spp., Agonoscena spp., Aleurodes spp., Aleurolobus barodensis, Aleurothrixus spp., Amrasca spp., Anuraphis cardui, Aonidiella spp., Aphanostigma piri, Aphis spp., Arboridia apicalis, Aspidiella spp., Aspidiotus spp., Atanus spp., Aulacorthum solani, Bemisia spp., Brachycaudus helichrysii, Brachycolus spp., Brevicoryne brassicae, Calligypona marginata, Carneocephala fulgida, Ceratovacuna lanigera, Cercopidae, Ceroplastes spp., Chaetosiphon fragaefolii, Chionaspis tegalensis, Chlorita onukii, Chromaphis juglandicola, Chrysomphalus ficus, Cicadulina mbila, Coccomytilus halli, Coccus spp., Cryptomyzus ribis, Dalbulus spp., Dialeurodes spp., Diaphorina spp., Diaspis spp., Doralis spp., Drosicha spp., Dysaphis spp., Dysmicoccus spp., Empoasca spp., Eriosoma spp., Erythroneura spp., Euscelis bilobatus, Geococcus coffeae, Homalodisca coagulata, Hyalopterus arundinis, Icerya spp., Idiocerus spp., Idioscopus spp., Laodelphax striatellus, Lecanium spp., Lepidosaphes spp., Lipaphis erysimi, Macrosiphum spp., Mahanarva fimbriolata, Melanaphis sacchari, Metcalfiella spp., Metopolophium dirhodum, Monellia costalis, Monelliopsis pecanis, Myzus spp., Nasonovia ribisnigri, Nephotettix spp., Nilaparvata lugens, Oncometopia spp., Orthezia praelonga, Parabemisia myricae, Paratrioza spp., Parlatoria spp., Pemphigus spp., Peregrinus maidis, Phenacoccus spp., Phloeomyzus passerinii, Phorodon humuli, Phylloxera spp., Pinnaspis aspidistrae, Planococcus spp., Protopulvinaria pyriformis, Pseudaulacaspis pentagona, Pseudococcus spp., Psylla spp., Pteromalus spp., Pyrilla spp., Quadraspidiotus spp., Quesada gigas, Rastrococcus spp., Rhopalosiphum spp., Saissetia spp., Scaphoides titanus, Schizaphis graminum, Selenaspidus articulatus, Sogata spp., Sogatella furcifera, Sogatodes spp., Stictocephala festina, Tenalaphara malayensis, Tinocallis caryaefoliae, Tomaspis spp., Toxoptera spp., Trialeurodes vaporariorum, Trioza spp., Typhlocyba spp., Unaspis spp., Viteus vitifolii.

From the order of the Hymenoptera, for example, Diprion spp., Hoplocampa spp., Lasius spp., Monomorium pharaonis, Vespa spp.

From the order of the Isopoda, for example, Armadillidium vulgare, Oniscus asellus, Porcellio scaber.

From the order of the Isoptera, for example, Reticulitermes spp., Odontotermes spp.

From the order of the Lepidoptera, for example, Acronicta major, Aedia leucomelas, Agrotis spp., Alabama argillacea, Anticarsia spp., Barathra brassicae, Bucculatrix thurberiella, Bupalus piniarius, Cacoecia podana, Capua reticulana, Carpocapsa pomonella, Cheimatobia brumata, Chilo spp., Choristoneura fumiferana, Clysia ambiguella, Cnaphalocerus spp., Earias insulana, Ephestia kuehniella, Euproctis chrysorrhoea, Euxoa spp., Feltia spp., Galleria mellonella, Helicoverpa spp., Heliothis spp., Hofmannophila pseudospretella, Homona magnanima, Hyponomeuta padella, Laphygma spp., Lithocolletis blancardella, Lithophane antennata, Loxagrotis albicosta, Lymantria spp., Malacosoma neustria, Mamestra brassicae, Mocis repanda, Mythimna separata, Oria spp., Oulema oryzae, Panolisfiammea, Pectinophora gossypiella, Phyllocnistis citrella, Pieris spp., Plutella xylostella, Prodenia spp., Pseudaletia spp., Pseudoplusia includens, Pyrausta nubilalis, Spodoptera spp., Thermesia gemmatalis, Tinea pellionella, Tineola bisselliella, Tortrix viridana, Trichoplusia spp.

From the order of the Orthoptera, for example, Acheta domesticus, Blatta orientalis, Blattella germanica, Gryllotalpa spp., Leucophaea maderae, Locusta spp., Melanoplus spp., Periplaneta americana, Schistocerca gregaria.

From the order of the Siphonaptera, for example, Ceratophyllus spp., Xenopsylla cheopis.

From the order of the Symphyla, for example, Scutigerella immaculata.

From the order of the Thysanoptera, for example, Baliothrips biformis, Enneothrips flavens, Frankliniella spp., Heliothrips spp., Hercinothrips femoralis, Kakothrips spp., Rhipiphorothrips cruentatus, Scirtothrips spp., Taeniothrips cardamoni, Thrips spp.

From the order of the Thysanura, for example, Lepisma saccharina.

The phytoparasitic nematodes include, for example, Anguina spp., Aphelenchoides spp., Belonoaimus spp., Bursaphelenchus spp., Ditylenchus dipsaci, Globodera spp., Heliocotylenchus spp., Heterodera spp., Longidorus spp., Meloidogyne spp., Pratylenchus spp., Radopholus similis, Rotylenchus spp., Trichodorus spp., Tylenchorhynchus spp., Tylenchulus spp., Tylenchulus semipenetrans, Xiphinema spp.

If appropriate, the compounds according to the invention can, at certain concentrations or application rates, also be used as herbicides, safeners, growth regulators or agents to improve plant properties, or as microbicides, for example as fungicides, antimycotics, bactericides, viricides (including agents against viroids) or as agents against MLO (mycoplasma-like organisms) and RLO (rickettsia-like organisms). If appropriate, they can also be employed as intermediates or precursors for the synthesis of other active compounds.

In another embodiment this aspect of the invention, the compounds and compositions of the invention are suitable for controlling pests such as insects selected from the group consisting of Blatella germanica, Heliothis virescens, Leptinotarsa decemlineata, Tetramorium caespitum and combinations thereof.

In each aspect of the invention, the compounds and compositions of the invention can be applied against a single pest or combinations thereof.

The preferred formulations described herein can be formulated for oral, injectable or topical (pour-on) administration. If formulated for oral administration, the preferred dosage rate is about 200 micrograms (mcg) of the anthelmintic compound per kg of the animal's live weight. If formulated for injectable administration, the preferred dosage rate is about 200 mcg of the anthelmintic compound per kg of the animal's live weight. If formulated for topical administration, the preferred dosage rate is about 500 mcg of the anthelmintic compound per kg of the animal's live weight. For example, if the macrocyclic lactone is present in an amount of about 1% w/v, an oral formulation would preferably be administered in an amount of 1 ml per 5 kg of the animal's live weight, an injectable formulation would preferably be administered in an amount of 1 ml per 50 kg of the animal's live weight, and a pour-on formulation would preferably be administered in an amount of 1 ml per 20 kg of the animal's live weight.

The composition containing the anthelmintic compound of the invention may be administered continuously, for treatment or prophylaxis, by known methods. Generally, a dose of from about 0.001 to about 50 mg per kg of body weight given as a single dose or in divided doses for a period of from 1 to 5 days will be satisfactory but, of course, there can be instances where higher or lower dosage ranges are indicated, and such are within the scope of this invention. It is well within the routine skill of the practitioner to determine a particular dosing regimen for a specific host and parasite.

In one treatment embodiment, the treatment is carried out so as to administer to the animal, on a single occasion, a dose containing between about 0.001 and about 100 mg/kg of the anthelminticcompound or between about 0.1 and about 200 μg/kg or about 100 μg/kg of compound. In another treatment embodiment, the treatment is via a direct topical administration such as a paste, pour-on, ready-to-use, spot-on, etc. type formulation. Higher amounts may be provided for very prolonged release in or on the body of the animal. In another treatment embodiment, the amount of anthelminticcompound for birds and animals which are small in size is greater than about 0.01 mg, and in another embodiment for the treatment of small sized birds and animals, the amount of anthelminticcompound is between about 1 and about 100 mg/kg of weight of animal.

The solutions according to the invention may be applied using any means known per se, e.g. using an applicator gun or a metering flask.

This method serves to cleanse the skin and the hairs of the animals by eliminating the parasites which are present thereon, as well as their residues and dejections. The result of this is that the animals are no longer stressed by the parasites and their bites, this having positive consequences, for example on their growth and on the use of their food ration.

In one embodiment, a direct pour-on skin formulation according to the present invention can provide long-lasting and broad-spectrum efficacy when the solution is applied to the animal's back, e.g. along the line of the back at one or more points.

According to a first embodiment for administering direct pour-on formulations, the process comprises applying the solution to the animals, the application being repeated every month or every two months.

According to a second embodiment for administering direct pour-on formulation, the process comprises applying the solution to livestock animals before they arrive in the Feed Lot, it being possible for this application to be the final one before the animals are slaughtered.

Obviously, the process may also consist in combining these two embodiments, namely the first followed by the second.

In another embodiment, the compounds of the invention are administered in spot-on formulations. While not wishing to be bound by theory, it is believed that these formulations work by dissolution of the dose in the natural oils of the host's skin, fur or feathers. From there, the active agent(s) distribute around the host's body through the sebaceous glands of the skin. The therapeutic agent also remains in the sebaceous glands. Thus, the glands provide a natural reservoir for the active agent that allows for the agent to be drained back out to the follicles to reapply itself to the skin and hair. This, in turn, provides for longer time periods between application as well as eliminating the need to re-administer the dose after the host becomes wet because of rain, bathes, etc. The inventive formulation has the further advantage of not being directly deposited on the skin or fur, where self-grooming animals could orally ingest the therapeutic agent, thereby becoming sick or possibly interacting with other therapeutic agent being orally administered.

In one embodiment of the location of administration, a single formulation containing the active agent in a substantially liquid carrier and in a form which makes possible a single application, or an application repeated a small number of times, will be administered to the animal over a localized region of the animal, e.g. between the two shoulders. In one embodiment of the invention, the localized region has a surface area of about 10 cm or larger. In another embodiment of the invention, the localized region has a surface are of between about 5 and about 10 cm² area.

The invention will now be further described by way of the following non-limiting examples.

### Example

Experiments were conducted to determine if improvements could be made to a pre-existing anti-parasitic formulation containing an avermectin, benzyl alcohol and a vegetable oil, in order to prevent or minimize the occurrence of crystallization of the avermectin over time. Various co-solvents were tested to determine whether a more stable formulation could be obtained.

Materials and Methods

A number of formulations were prepared containing a macrocyclic lactone with different solvents in various ratios. These formulations were prepared in the following manner:

Abamectin in an amount of 1% w/v or 10 g/L was dissolved in a selected quantity of benzyl alcohol and the resultant solution was then admixed with either soya bean oil alone or with blends of:
soya bean oil and castor oil
medium chain mono- and di-glycerides and soya bean oil

The formulations were then stored either at room temperature or under refrigeration for a period of three weeks. At certain times the formulations were removed from storage and studied under high-powered microscope to determine the presence or absence of crystals in the solution.

Results

The following key was used to record the results:

KEY

XXX=heavy crystallization

XX=light-moderate crystallization

X=trace-light crystallization

0=no crystallization

### Formulations Stored at Room Temperature

| | | Amount of crystallization | | | |
|---|---|---|---|---|---|
| % | | present | | | |
| Benzyl | | 1 | 3 | 2 | 3 |
| Alcohol | Solvent(s) | day | days | weeks | Weeks |
| 15 | Soya bean oil to vol. | X | X | XXX | XXX |
| 15 | Soya bean oil to vol. | XX | XX | XXX | XXX |
| 15 | 5% castor oil & soya bean oil | X | X | XX | XXX |
| | to vol. | | | | |
| 15 | 5% castor oil & soya bean oil | XX | X | XX | XXX |
| | to vol. | | | | |
| 15 | 5% medium chain mono- and | 0 | 0 | X | X |
| | diglycerides & soya bean oil | | | | |
| | to vol. | | | | |
| 15 | 5% medium chain mono- and | 0 | 0 | X | XX |
| | diglycerides & soya bean oil | | | | |
| | to vol. | | | | |
| 20 | Soya bean oil to vol. | 0 | 0 | X | X |
| 20 | Soya bean oil to vol. | 0 | 0 | X | X |
| 20 | Soya bean oil to vol. | 0 | 0 | X | X |
| 20 | 5% medium chain mono- and | 0 | 0 | X | X |
| | diglycerides & soya bean oil | | | | |
| | to vol. | | | | |
| 20 | 5% medium chain mono- and | 0 | 0 | X | X |
| | diglycerides & soya bean oil | 0 | 0 | X | X |
| | to vol. | | | | |
| 20 | 5% castor oil & soya bean oil | 0 | 0 | 0 | 0 |
| | to vol. | | | | |
| 20 | 5% castor oil & soya bean oil | 0 | 0 | 0 | 0 |
| | to vol. | | | | |
| 20 | 5% castor oil & soya bean oil | 0 | 0 | 0 | 0 |
| | to vol. | | | | |

### Formulations Stored Under Refrigeration at 2-8° C.

| | | Amount of |
|---|---|---|
| | | crystallization |
| % Benzyl | | present after |
| Alcohol | Solvent(s) | 3 weeks |
| 15 | Soya bean oil to vol. | XX |
| 15 | Soya bean oil to vol. | XX |
| 15 | 5% castor oil & soya bean oil to vol. | XX |
| 15 | 5% castor oil & soya bean oil to vol. | XX |
| 15 | 5% medium chain mono- and diglycerides & | X |
| | soya bean oil to vol. | |
| 15 | 5% medium chain mono- and diglycerides & | X |
| | soya bean oil to vol. | |
| 20 | Soya bean oil to vol. | 0 |
| 20 | Soya bean oil to vol. | 0 |
| 20 | Soya bean oil to vol. | 0 |
| 20 | 5% medium chain mono- and diglycerides & | XX |
| | soya bean oil to vol. | |
| 20 | 5% medium chain mono- and diglycerides & | X |
| | soya bean oil to vol. | |
| 20 | 5% medium chain mono- and diglycerides & | X |
| | soya bean oil to vol. | |
| 20 | 5% castor oil & soya bean oil to vol. | 0 |
| 20 | 5% castor oil & soya bean oil to vol. | 0 |
| 20 | 5% castor oil & soya bean oil to vol. | 0 |

The results demonstrated that when stored at both room temperature as well as under refrigeration, the formulations containing abamectin in a solution of 20% benzyl alcohol combined with 5% castor oil appeared to have a significantly lower potential for crystallisation when compared to formulations containing:
15% benzyl alcohol and other co-solvents;
20% benzyl alcohol and soya bean oil only;
20% benzyl alcohol, medium chain mono- and diglycerides (e.g. Capmul MCM) and soya bean oil.

To confirm these findings, 10 mg/mL of abamectin was mixed with varying ratios of benzyl alcohol and castor oil and made up to volume with soya bean oil. Heat was not applied during the preparation of the formulations. The various formulations were observed to see if crystallization occurred after periods of 1 day, 3 days, 1 week and 2 weeks. The following results were observed, using the same key as above:

| | | |
|---|---|---|
| % | | |
| Benzyl | % | Amount of crystallisation present |

| Alcohol | Castor Oil | 1 day | 3 days | 1 week | 2 weeks |
|---|---|---|---|---|---|
| 20 | 5 | 0 | 0 | 0 | 0 |
| 15 | 10 | 0 | X | X | X |
| 10 | 15 | 0 | X | XX | XXX |
| 5 | 20 | 0 | X | XX | XXX |

The results confirmed that a preferred ratio of solvents in this formulation is 20% benzyl alcohol combined with 5% of castor oil. Ratios of 15% and less of benzyl alcohol combined with higher amounts of castor oil were not as effective at preventing or minimizing crystallization.

It is likely that formulations containing at least 17% of the co-solvent selected from the group of alcohols comprising four or more carbon atoms with 5% or more of castor oil would also be effective, and further studies will be carried out to determine the preferred lower limit of the alcohol co-solvent.

Tests were also conducted to determine the preferred upper limit of the amount of castor oil that could be included in the formulation, due to the relatively high viscosity levels of castor oil. Formulations containing various amounts of benzyl alcohol and castor oil were tested and the following viscosity measurements were observed:

| | | Viscosity |
|---|---|---|
| % Benzyl Alcohol | % Castor Oil | (seconds) |
| 20 | 5 | 17 |
| 20 | 10 | 18 |
| 20 | 15 | 19 |
| 20 | 20 | 20 |
| 20 | 25 | 21 |
| Neat soya bean oil | | 21 |
| Neat castor oil | | 176 |

These results show that it is preferable for the castor oil to be present in the formulation in an amount of no more than 25% w/v. Formulations containing more than 25% w/v of castor oil would have an unacceptably high viscosity that would make the formulation difficult to administer through administration devices such as pour-on applicator guns, syringes and drenching guns. This is due to the significant difference in inherent viscosity between neat soya bean oil and neat castor oil.

The preferred formulations described herein can be formulated for oral, injectable or topical (pour-on) administration. If formulated for oral administration, the preferred dosage rate is about 200 mcg of the anthelmintic compound per kg of the animal's live weight. If formulated for injectable administration, the preferred dosage rate is about 200 mcg of the anthelmintic compound per kg of the animal's live weight. If formulated for topical administration, the preferred dosage rate is about 500 mcg of the anthelmintic compound per kg of the animal's live weight. For example, if the macrocyclic lactone is present in an amount of about 1% w/v, an oral formulation would preferably be administered in an amount of 1 ml per 5 kg of the animal's live weight, an injectable formulation would preferably be administered in an amount of 1 ml per 50 kg of the animal's live weight, and a pour-on formulation would preferably be administered in an amount of 1 ml per 20 kg of the animal's live weight.

Although abamectin is used as the active ingredient in the preferred formulations described herein, it is envisaged that other macrocyclic lactones including but not limited to ivermectin, doramectin, eprinomectin, selamectin and moxidectin could be used in the formulations.

Although benzyl alcohol is used in the preferred formulations described herein, it is envisaged that other solvents, including other alcohol solvents or mixtures of alcohol solvents may be used in the inventive formulations. Alcohol solvents that may be used in the formulations include, but are not limited to,alcohols having four or more carbon atoms, for example, ethyl benzyl alcohol, phenethyl alcohol and other aromatic monohydric alcohols. These solvents, or mixtures thereof, may be used in place of benzyl alcohol, or in combination with benzyl alcohol.

Although soya bean oil is used in the preferred formulations described herein, it is envisaged that other vegetable oils (other than castor oil) could be used in the formulations in place of soya bean oil, for example, sesame oil, corn oil and the like.

Other oil soluble actives may also be added to the formulations, for example, oil soluble vitamins.

Although heat was not applied during the preparation of the preferred formulations described herein, the Applicant believes that applying heat during the preparation of the formulations is likely to have an effect on the solubility of the active ingredient(s). Further studies will be carried out to determine the effects of heating the formulation and whether or not this aids in the prevention or minimization of crystallization.

Advantages
a) The active ingredient does not crystallize or precipitate out of the formulation over time;
b) The formulation is easy to prepare;
c) The formulation has a high viscosity;
d) The excipients are of low cost.

The invention is further described by the following numbered paragraphs:

1. An anti-parasitic formulation comprisone or more alcohol a co-solvents having four or more carbon atoms present in an amount of at least 17% by weight, (c) castor oil present in an amount of 25% by weight or less, and (d) a vegetable oil wherein the vegetable oil is an oil other than castor oil.

2. The formulation of paragraph 1 wherein the anthelmintic compound is selected from the group comprising abamectin, ivermectin, moxidectin, doramectin and eprinomectin.

3. The formulation of paragraph 1 or 2 wherein the anthelmintic compound is present in an amount of about 1% by weight of the formulation.

4. The formulation of any one of paragraphs 1-3 wherein the vegetable oil is selected from the group comprising soya bean oil, sesame oil and corn oil.

5. The formulation of any one of paragraphs 1-4 wherein the co-solvent is benzyl alcohol.

6. The formulation of paragraph 5 wherein the benzyl alcohol is present in an amount of between about 17 and 25% w/v.

7. The formulation of any one of paragraphs 1-4 wherein a first co-solvent is benzyl alcohol.

8. The formulation of any one of paragraphs 1-7 wherein the castor oil is present in an amount of between about 4 and 25% w/v, advantageously in an amount of about 5% w/v.

9. An anti-parasitic formulation comprising an anthelmintic compound selected from the class of macrocyclic lactones, together with a vegetable oil selected from the group comprising soya bean oil, sesame oil and corn oil, a co-solvent selected from the group consisting of alcohols having four or more carbon atoms, and castor oil, wherein the co-solvent is present in an amount of at least 17% by weight and the castor oil is present in an amount of 25% by weight or less.

10. The formulation of paragraph 9 wherein the anthelmintic compound is selected from the group comprising abamectin, ivermectin, moxidectin, doramectin and eprinomectin.

11. The formulation of paragraph 9 or 10 wherein the anthelmintic compound is present in an amount of about 1% by weight of the formulation.

12. The formulation of any one of paragraphs 9-11 wherein the co-solvent is benzyl alcohol.

13. The formulation of paragraph 12 wherein the benzyl alcohol is present in an amount of between about 17 and 25% w/v.

14. The formulation of any one of paragraphs 9-12 wherein the castor oil is present in an amount of between about 4 and 25% w/v, advantageously in an amount of about 5% w/v.

15. A method of treating a livestock animal to prevent or decrease the level of infection by endo- and/or ecto-parasites, comprising administering to the livestock animal an anti-parasitic formulation of any one of paragraphs 1-14.

16. The method of paragraph 15 wherein the administration is topical or pour-on.

17. The method of paragraph 16 wherein the formulation is administered in an amount of 500 mcg of the anthelmintic compound per kg of the animal's live weight.

18. The method of paragraph 16 wherein the formulation is administered at a dosage rate of 1 ml per 20 kg of the animal's live weight.

19. The method of paragraph 15 wherein the administering is injectable.

20. The method of paragraph 19 wherein the formulation is administered in an amount of 200 mcg of the anthelmintic compound per kg of the animal's live weight.

21. The method of paragraph 19 wherein the formulation is administered at a dosage rate of 1 ml per 50 kg of the animal's live weight.

22. The method of paragraph 15 wherein the administration is oral.

23. The method of paragraph 22 wherein the formulation is administered in an amount of 200 mcg of the anthelmintic compound per kg of the animal's live weight.

24. The method of paragraph 22 wherein the formulation is administered at a dosage rate of 1 ml per 5 kg of the animal's live weight.

Having thus described in detail preferred embodiments of the present invention, it is to be understood that the invention defined by the above paragraphs is not to be limited to particular details set forth in the above description as many apparent variations thereof are possible without departing from the spirit or scope of the present invention.

What is claimed is:

1. An anti-parasitic formulation comprising:
(a) one or more anthelmintic compounds, wherein the compound is abamectin, ivermectin, moxidectin, doramectin or eprinomectin,
(b) a co-solvent present in an amount of at least 17% by weight wherein the co-solvent is an alcohol having four or more carbon atoms,
(c) a castor oil present in an amount of 25% by weight or less, and
(d) a vegetable oil wherein the vegetable oil is an oil other than castor oil.

2. The formulation of claim 1 wherein the anthelmintic compound is present in an amount of about 1% by weight of the formulation.

3. The formulation of claim wherein the vegetable oil is soya bean oil, sesame oil or corn oil.

4. The formulation of claim 1 wherein the co-solvent is benzyl alcohol.

5. The formulation of claim 4 wherein the benzyl alcohol is present in an amount of between about 17 and 25% w/v.

6. The formulation of claim 1 wherein the castor oil is present in an amount of between about 4 and 25% w/v.

7. The formulation of claim 6 wherein the castor oil is present in an amount of about 5% w/v.

8. A method of treating a livestock animal to prevent or decrease the level of infection by endo- and/or ecto-parasites, comprising administering to the livestock animal an effective amount of the anti-parasitic formulation of claim 1.

9. The method of claim 8 wherein the administration is topical or pour-on.

10. The method of claim 9 wherein the formulation is administered in an amount of 500 mcg of the anthelmintic compound per kg of the animal's live weight.

11. The method of claim 9 wherein the formulation is administered at a dosage rate of 1 ml per 20 kg of the animal's live weight.

12. The method of claim 8 wherein the administering is injectable.

13. The method of claim 12 wherein the formulation is administered in an amount of 200 mcg of the anthelmintic compound per kg of the animal's live weight.

14. The method of claim 12 herein the formulation is administered at a dosage rate of 1 ml per 50 kg of the animal's live weight.

15. The method of claim 8 wherein the administration is oral.

16. The method of claim 15 wherein the formulation is administered in an amount of 200 mcg of the anthelmintic compound per kg of the animal's live weight.

17. The method of claim 15 wherein the formulation is administered at a dosage rate of 1 ml per 5 kg of the animal's live weight.
